(19) United States
(12) Patent Application Publication
(10) Pub. No.: US 2013/0075983 A1
(43) Pub. Date: Mar. 28, 2013

(54) CHIPPING HAMMER CLAMPING STRUCTURE FOR A PNEUMATIC TOOL

(71) Applicant: Wen-Liang HSIAO, New Taipei City (TW)

(72) Inventor: Wen-Liang HSIAO, New Taipei City (TW)

(21) Appl. No.: 13/240,089

(22) Filed: Sep. 22, 2011

(51) Int. Cl. B25D 17/08

(52) U.S. Cl. 279/4.04

(57) ABSTRACT

A chipping hammer clamping structure for a pneumatic tool includes primarily a grip which is filled in with high-pressure air, an air cylinder which is connected with the grip, a braking unit which is at a front end of the air cylinder, an inner rim of which is a support part and which can move along the air cylinder, and a shield which is sheathed at a rear rim of the air cylinder and is combined with the grip. When in use, as the air cylinder is formed integrally, the chipping hammer can be more robust to increase a striking force. Besides, dust and particles produced in operation are discharged from the groove at the front rim of the shield, thereby avoiding contamination to an operator.

### BACKGROUND OF THE INVENTION

a) Field of the Invention

The present invention relates to a chipping hammer clamping structure for a pneumatic tool, and more particularly to a chipping hammer clamping structure for a pneumatic tool which, when in use, allows the chipping hammer to be more robust to increase a striking force, and enables dust, particles to be discharged from a groove at a front rim of a shield to avoid causing contamination to an operator.

b) Description of the Prior Art

Referring to FIG. 1, an ordinary pneumatic tool includes generally a grip 11, an air cylinder 12, an annular unit 13 which is provided at a front end of the air cylinder 12 and can move along the air cylinder 12, and a shield 14 which is sheathed at a rear rim of the air cylinder 12 and is combined with the grip 11, allowing a chipping hammer 15 to be inserted and fixed at the front end of the air cylinder 12. As a gap between the annular unit 13 and a blocking ring 16 at the air cylinder 12 is too large, the striking force is decreased and the entire chipping hammer 15 can even drop out to result in danger. Due to that exhaust vents 17 of a conventional pneumatic tool are provided on an upper rim of the shield 14, dust and particles that are produced during operation will be discharged upward from the exhaust vents 17, causing contamination to the operator. Accordingly, the present invention discloses a chipping hammer clamping structure for a pneumatic tool which enables the chipping hammer of the pneumatic tool to be more robust and prevents the operator from being contaminated by the dust and particles produced during operation.

### SUMMARY OF THE INVENTION

The primary object of the present invention is to provide a chipping hammer clamping structure for a pneumatic tool, allowing that the chipping hammer can be more robust to increase the striking force and that the dust, particles can be discharged from a groove at a front rim of a shield to avoid contamination to the operator, when the pneumatic tool is in use.

The abovementioned chipping hammer clamping structure for a pneumatic tool includes a grip which is filled in with high-pressure air, an air cylinder which is connected with the grip, a braking unit which is provided at a front end of the air cylinder, an inner rim of which is provided with a support part and which can move along the air cylinder, as well as a shield which is sheathed at a rear rim of the air cylinder and is combined with the grip. The air cylinder is formed integrally and a front rim thereof is provided with a step part. A front section of the step part is provided with plural through-holes which are arranged symmetrically and an inner rim of each of which is converged gradually with a smaller diameter for putting in a steel shot. The rear rim of the air cylinder is provided with symmetrical air vents and a front rim of the shield is provided with a groove of separation. The chipping hammer is fixed at the air cylinder by supporting the steel shots with the support part of the braking unit, and the chipping hammer can be more robust to increase the striking force when in use, as the air cylinder is formed integrally. In addition, the dust and particles formed during operation are discharged from the groove at the front rim of the shield, which avoids contamination to the operator.

For the abovementioned chipping hammer clamping structure for a pneumatic tool, a rim of an opening at the front end of the shield is provided with continuous inner and outer arc portions to form the groove of separation.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a conventional pneumatic tool.

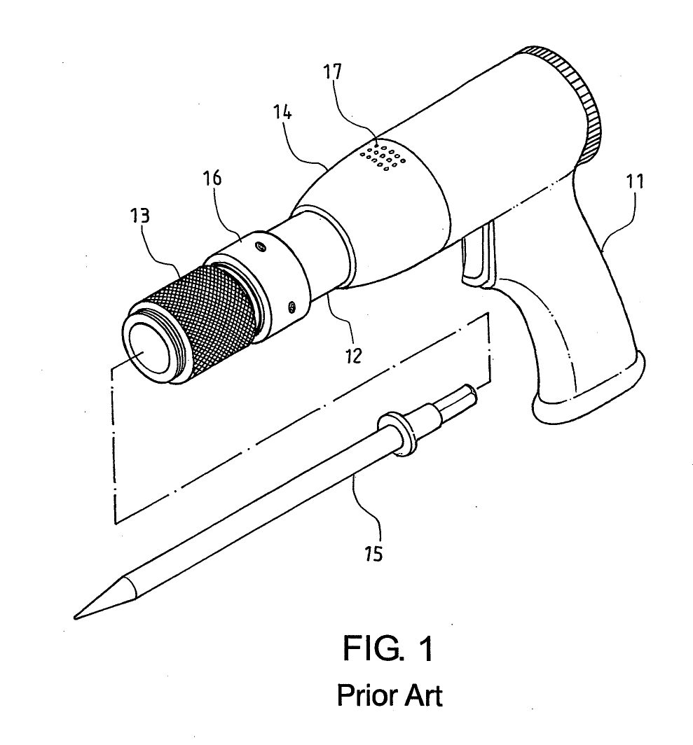

FIG. 2 shows a three-dimensional view of the present invention.

FIG. 3 shows a three-dimensional exploded view of the present invention.

FIG. 4 shows a cutaway view of the present invention.

FIG. 5 shows a schematic view of an implementation of use of the present invention.

FIG. 6 shows another schematic view of an implementation of use of the present invention.

### DETAILED DESCRIPTION OF THE PREFERRED EMBODIMENTS

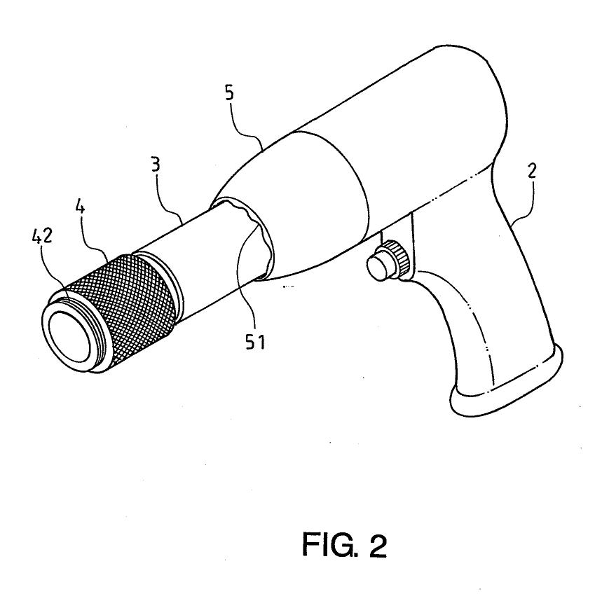

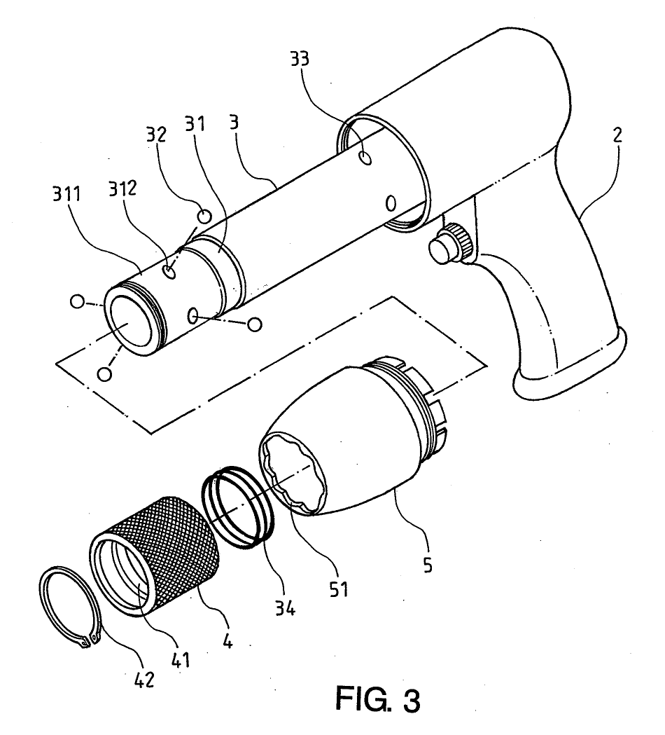

Referring to FIG. 2 and FIG. 3 at a same time, it shows a three-dimensional view and a three-dimensional exploded view of the present invention. As shown in the drawings, the present invention comprises a grip 2 which is filled in with high-pressure air, an air cylinder 3 which is connected with the grip 2, a braking unit 4 which is provided at a front end of the air cylinder 3 and can move along the air cylinder 3, as well as a shield 5 which is sheathed at a rear rim of the air cylinder 3 and is combined with the grip 2. The grip 2 provides for filling in with high-pressure air, the air cylinder 3 is formed integrally, a proper position at a front rim thereof is provided with a step part 31, and a front section 311 of the step part 31 is provided with plural through-holes 312 which are arranged symmetrically. An inner rim of the through-hole 312 is converged gradually with a smaller diameter, allowing a steel shot 32 to be put into the through-hole 312 that the steel shot 32 is protruded inward from the through-hole 312 by a part of volume. The rear rim of the air cylinder 3 is provided with symmetric air vents 33.

The braking unit 4 is an annular unit and a proper position at an inner rim thereof is provided with a protruded support part 41, such that after the step part 31 of the air cylinder 3 has been sheathed with a spring 34, the braking unit 4 can be sheathed at the front section 311 of the step part 31, followed by being fixed at the front end of the air cylinder 3 to form positioning by a C-ring 42. Therefore, by elasticity of the spring 34, the braking unit 4 can move at the front section 311 of the air cylinder 3.

A front rim of the shield 5 is provided with a groove 51 of separation, wherein a rim of an opening at a front end of the shield 5 is provided with continuous inner and outer arc portions to form the groove 51 of separation.

By assembling the aforementioned components, when the pneumatic tool is in use, the chipping hammer is inserted in an opening at the front end of the air cylinder 3 and with support to the steel shots 32 by the support part 41 of the braking unit 4, the chipping hammer is fixed at the air cylinder 3. As the air cylinder 3 is formed integrally, the chipping hammer can be more robust to increase a striking force. In addition, during operation, dust and particles which are discharged from the air vents 33 can be discharged forward from the groove 51 at the front rim of the shield 5, thereby avoiding contamination to an operator.

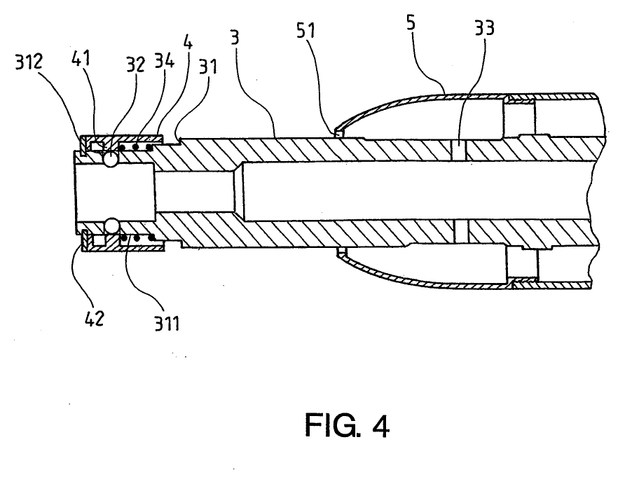

Referring to FIG. 4, it shows a cutaway view of the present invention. As shown in the drawing, after the present invention has been assembled, the support part 41 of the braking unit 4 will constitute the support to the steel shots 32 by elastic tension of the spring 34 during a normal condition; whereas, when the braking unit 4 is pushed backward that the support part 41 escapes from the steel shots 32, the steel shots 32 can move upward, allowing the chipping hammer to be inserted to be fixed or pulled out to escape. Besides, the air vents 33 that are provided at the rear rim of the air cylinder 3 are encased by the shield 5, allowing the dust and particles that are discharged from the air vents 33 to be discharged forward from the groove 51 at the front rim of the shield 5, along an interior of the shield 5.

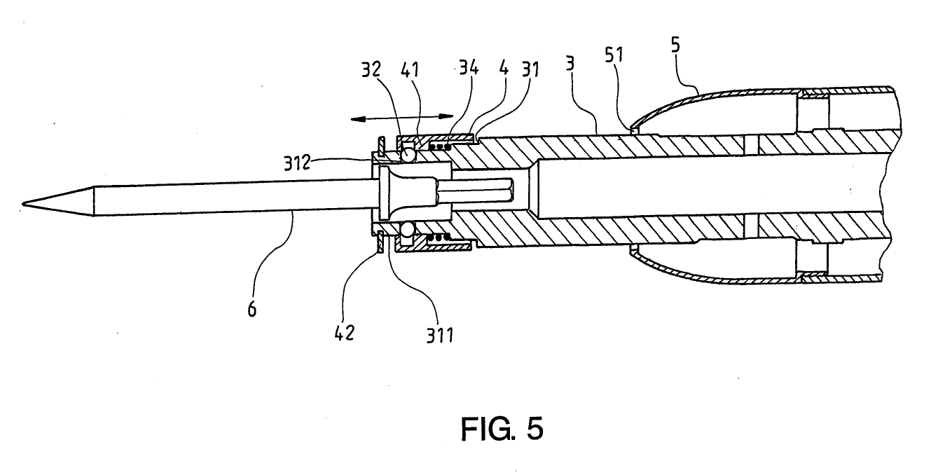

Referring to FIG. 5, it shows a schematic view of an implementation of use of the present invention. As shown in the drawing, when the present invention is in use, the braking unit 4 is pushed backward that the support part 41 at the inner rim escapes from the steel shots 32, allowing the steel shots 32 to move upward, so that after inserting the chipping hammer 6, the braking unit 4 will be restored by the elastic tension of the spring 34, thereby enabling the support part 41 to support the steel shots 32 to fix the chipping hammer 6. On the other hand, after use, the braking unit 4 is then pushed backward again, so that the support part 41 at the inner rim can escape from the steel shots 32 to pull out the chipping hammer 6.

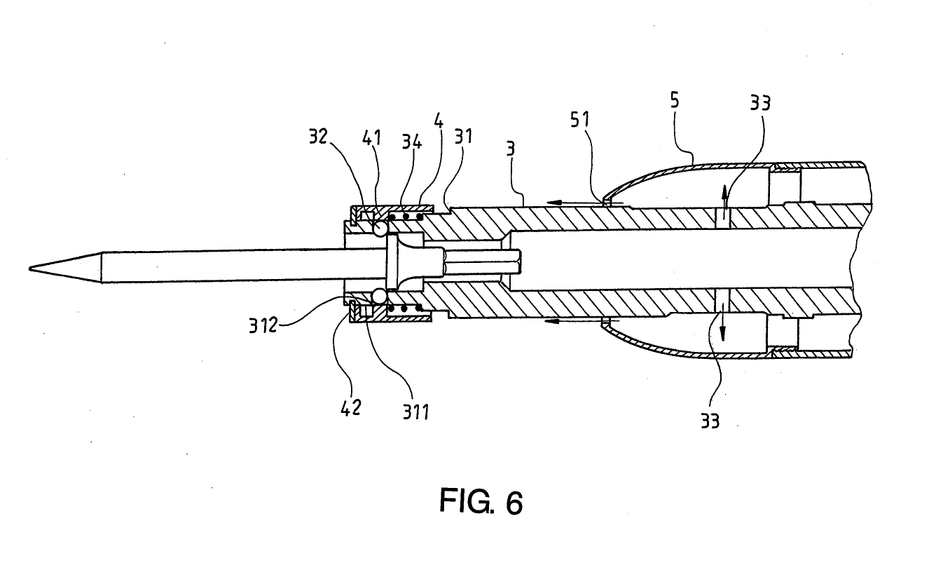

Referring to FIG. 6, it shows another schematic view of an implementation of use of the present invention. As shown in the drawing, the dust and particles produced when the present invention is in use are discharged from the air vents 33 of the air cylinder 3. As the air vents 33 at the rear rim of the air cylinder 3 are encased by the shield 5, the dust and particles that are discharged form the air vents 33 can be discharged forward from the groove 51 at the front rim of the shield 5 along the interior of the shield 5, without causing contamination to the operator like the conventional pneumatic tool where the dust and particles are discharged upward, thereby enabling the pneumatic tool to be used more safely.

Accordingly, in the present invention, a chipping hammer clamping structure for a pneumatic tool is constituted by the air cylinder which is formed integrally and is provided with the air vents, in association with the braking unit and the shield. By the present invention, when the pneumatic tool is in use, the chipping hammer can be more robust to increase the striking force. In addition, the dust and particles produced in operation can be discharged from the groove at the front rim of the shield to avoid contamination to the operator.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A chipping hammer clamping structure for a pneumatic tool, comprising:
a grip which is filled in with high-pressure air;
an air cylinder, which is formed integrally and is connected with the grip, and a proper position at a front rim of which is provided with a step part, with that a front section of the step part is provided with plural through-holes arranged symmetrically, the through-holes provide for putting in steel shots, and a rear rim of the air cylinder is provided with symmetric air vents;
a braking unit, which is an annular unit, a proper position at an inner rim of which is provided with a protruded support part; and
a shield, a front rim of which is provided with a groove of separation;
when assembling, the chipping hammer being inserted in an opening at a front end of the air cylinder and the chipping hammer being fixed at the air cylinder by supporting the steel shots with the support part of the braking unit, allowing the chipping hammer to be more robust to increase a striking force; in addition, dust and particles that are produced in operation and are discharged from the air vents being discharged forward from the groove at the front rim of the shield, avoiding contamination to an operator.

2. The chipping hammer clamping structure for a pneumatic tool, according to claim 1, wherein an inner rim of the through-hole that is provided at the front section of the air cylinder is converged gradually with a smaller diameter, allowing the steel shot to be protruded inward from the through-hole by a part of volume.

3. The chipping hammer clamping structure for a pneumatic tool, according to claim 1, wherein a rim of an opening at a front end of the shield is provided with continuous inner and outer arc portions to form the groove of separation.

4. The chipping hammer clamping structure for a pneumatic tool, according to claim 1, wherein after being sheathed in, the braking unit is fixed at the front end of the air cylinder by a C-ring to constitute positioning to the braking unit.
